(19) United States
(12) Patent Application Publication
(10) Pub. No.: US 2006/0050643 A1
(43) Pub. Date: Mar. 9, 2006

(54) Router for multicast redundant routing and system for multicast redundancy

(75) Inventors: Tetsuro Yoshimoto, Kokubunji (JP); Akihito Tuduki, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi Communication Technologies, Ltd.

(21) Appl. No.: 11/181,783

(22) Filed: Jul. 15, 2005

(30) Foreign Application Priority Data
Feb. 23, 2005 (JP) 2005-046438
Sep. 6, 2004 (JP) 2004-257827

(51) Int. Cl. H04L 12/26

(52) U.S. Cl. 370/241; 370/351

(57) ABSTRACT

In the IGMP/MLD Proxy, a link to an upper router must be formed in a tree structure. However, in this case, if a fault is generated in the link to the upper router, multicasts to the lower networks are all disabled. Plural links to the upper router may be set up using a routing protocol such as PIM, but light and easier operations of the IGMP/MLD Proxy are lost. In view of solving this problem, alternative links may be set in addition to the links which are usually used as the links to the upper router. Usually, the IGMP/MLD is exchanged only with the links which are usually used but with the alternative link. If link-off is detected in the link to the upper router used generally, the IGMP Membership Report/MLD Listener Report packet is transmitted to the side of the alternative link and thereafter the upper link is switched through exchanges of the IGMP/MLD only with the side of the alternative link.

### CLAIM OF PRIORITY

The present application claims priority from Japanese application JP 2005-046438 filed on Feb. 23, 2005 and JP 2004-257827 field on Sep. 6, 2004, the contents of which are hereby incorporated by reference into this application.

### FIELD OF THE INVENTION

The present invention relates to routing of the IP multicast.

### BACKGROUND OF THE INVENTION

An ordinary IP packet transfer is based on the 1:1 communication. This is called the IP unicast. Meanwhile, an IP multicast technique has been proposed as the technique for realizing broadcast services such as video distribution using a network. This IP multicast technique is capable of transferring the IP packets transmitted from an information originating server to multiple hosts by branching the packets with a router provided on the IP network. Accordingly, the information originating server is no longer required to repeat the transmissions as many times as the number of hosts and thereby a load of this server may be alleviated. Moreover, since the packets having the identical contents are no longer transmitted many times via the identical route and thereby a load of the network as a whole can also be eased.

Multicast routing includes a protocol for PIM and DVMRP, but IGMP/MLD proxy can be set most easily and assures light operations. In this IGMP/MLD proxy, a gateway of LAN transmits at a time the IGMP(IPv4)/MLD(IPv6) which is the protocol for a host to take part in a multicast group to an upper hierarchy (hereinafter referred to only as upper) router. The IGMP is the protocol used by the IPv4 multicast, while the MLD is the protocol used by the IPv6 multicast. A gateway router processes participating and leaving messages to and from host for each multicast group, and transmits the multicast packets to all interfaces in which the participants exist. Moreover, it is verified periodically from the router whether the participants exist or not.

Since it is a precondition that a network has the tree structure, the protocols explained above are widely used at the terminals of a provider network, although not used in the entire part of the Internet, because of light operations and easier setting thereof.

### SUMMARY OF THE INVENTION

Subjects of the present invention will be explained below. FIG. 2 is a schematic diagram of a network in which the IGMP/MLD proxy is used. Numeral 1 denotes a router used for multicast distribution with the IGMP/MLD proxy. Numerals 2, 7 denote routers for multicast distribution using the PIM and DVMRP within the Internet. Numerals 5a, 5b are terminals for finally receiving multicast. Numeral 6 denotes a multicast distribution route formed on the Internet using the PIM and DVMRP. Numeral 8 denotes a server for transmitting first the multicast packets. The router 1 receives the multicast packets from the router 2 using a link 3 and transmits the multicast packets to the terminals 5a, 5b using the links 4a, 4b. In the Internet 9, the network does no have a tree structure, but in the IP network 10 under the management of a particular provider, the network has the tree structure in which the router 2 is located at the peak of the network.

FIG. 3 is a sequence diagram indicating the basic process of the multicast routing using the IGMP/MLD proxy in FIG. 2.

The router 2 periodically transmits an inquiry messages called the IGMP Membership Query/MLD Listener Query (hereinafter referred to as Query message) to the link 3 being set as the interface for accommodating the multicast terminal. This message arrives at the router 1 via the link 3 (S301). Meanwhile, the router 1 returns the IGMP Membership Report/MLD Listener Report (hereinafter referred to as Report message) when a multicast terminal under the management of the router 1 itself exists. However, since such terminal does not yet exist in this stage, no response is returned (S302).

The router 1 also periodically transmits the Query message, as the router 2 transmits, to the links 4a, 4b which is set by itself as the interface for accommodating the multicast terminals. These messages arrive respectively at the terminals 5a, 5b via the links 4a, 4b (S303a, S303b). However, no response is returned because the terminal is not yet in the situation to receive the multicast packets in this stage (S304a, S304b). Accordingly, the multicast packets transmitted via the router 7 from the server 8 arrive at the router 2 via the multicast route 6 but are no longer transmitted to the forward route (S305). When the terminal 5a enters the situation to receive the multicast packets, a Report message is temporarily transmitted to the link 4a. This messages arrives at the router 1 via the link 4a (S306). The router 1 having received the Report message performs the setting for the multicast transfer to the link 4a and simultaneously generates the Report message using the information received to temporarily transmit to the router 2. The Report message reaches the router 2 via the link 3 and the router 2 performs the setting for the multicast transfer to the link 3 (S307).

Accordingly, the multicast packets transmitted from the server 8 arrive at the terminal 5a via the routers 2 and 1. But, these multicast packets do not reach the terminal 5b (S308). When the terminal 5b enters the situation to receive the multicast packets, the terminal 5b transmits temporarily the Report message to the link 4b. This message reaches the router 1 via the link 4b (S309). The router 1 having received the Report message performs setting for multicast transfer to the link 4b. Since the Report message has already been transmitted to the router 2, the Report message is not temporarily transmitted (S310) in this case. Accordingly, the multicast packets transmitted from the server 8 are transmitted to both terminals 5a, 5b via the routers 2 and 1 (S311). When the Query message is received from the router 2 under the condition that the multicast terminal under the control of the router 1 exists (S312), the router 1 returns the Report message to the router 2 to indicate existence of the Query message within the multicast group (S313). Moreover, the terminals 5a, 5b under the situation to receive the multicast packets return the Report message to the Query message (S314a, S314b) from the router 1 to indicate existence in the multicast group (S315a, S315b).

As explained above, the link to the upper router must be constituted as a tree structure in the present IGMP/MLD Proxy. However, in this case, if a fault occurs in the link toward the upper router, the multicasts to the lower hierarchy (hereinafter referred to only as lower) network are all disabled. It is certainly possible to provide plural links to the upper router by using the routing protocol such as PIM, but light operation and simple structure of the IGMP/MLD Proxy are lost.

As a link to the upper router, it is made possible to set an alternative link in addition to those used regularly. In usual, only the link used ordinarily exchanges the IGMP/MLD, while the alternative link does not exchange the IGMP/MLD. When link-off to the upper router which is used ordinarily is detected, the IGMP Membership Report/MLD Listener Report packets are transmitted to the side of the alternative link and thereafter the upper router is switched through exchange of the IGMP/MLD only with the side of the alternative link.

Link-off may be detected with the following methods.
1) Supervising of link-off of a physical interface
2) Common use of the information of unicast routing
3) Supervising of IGMP/MLD Query

According to the present invention, redundancy of the link to the upper router can be realized while light operation and simple structure of the IGMP/MLD Proxy are maintained.

### BRIEF DESCRIPTION OF THE DRAWINGS

FIG. 1 is a sequence diagram illustrating behaviors of a total network in the present invention;

FIG. 2 is a structural diagram of the network for explaining problems of the invention;

FIG. 3 is a sequence diagram explaining behaviors of the total network for explaining problems of the invention;

FIG. 4 is a structural diagram of the network of the present invention;

FIG. 5 is a schematic diagram illustrating an internal structure of the IGMP/MLD Proxy router of the present invention;

FIG. 6 is a functional block diagram of the IGMP/MLD Proxy program of the present invention;

FIG. 7 is a functional block diagram of the IGMP/MLD Proxy program of the present invention;

FIG. 8 is a functional block diagram of the IGMP/MLD Proxy program of the present invention; and

FIG. 9 is a diagram of group database of the present invention.

### DETAILED DESCRIPTION OF THE PREFERRED EMBODIMENTS

### First Embodiment

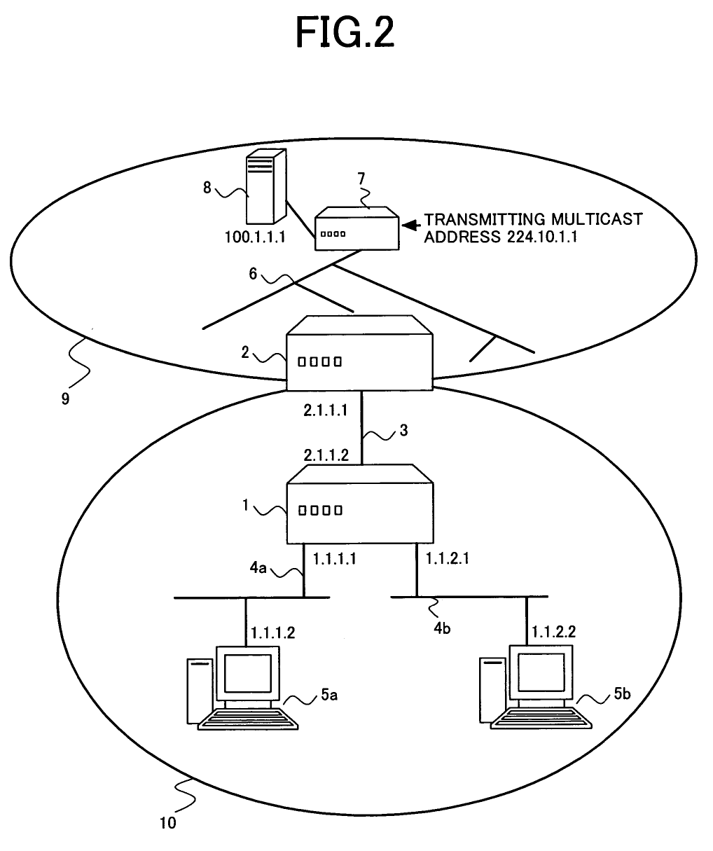

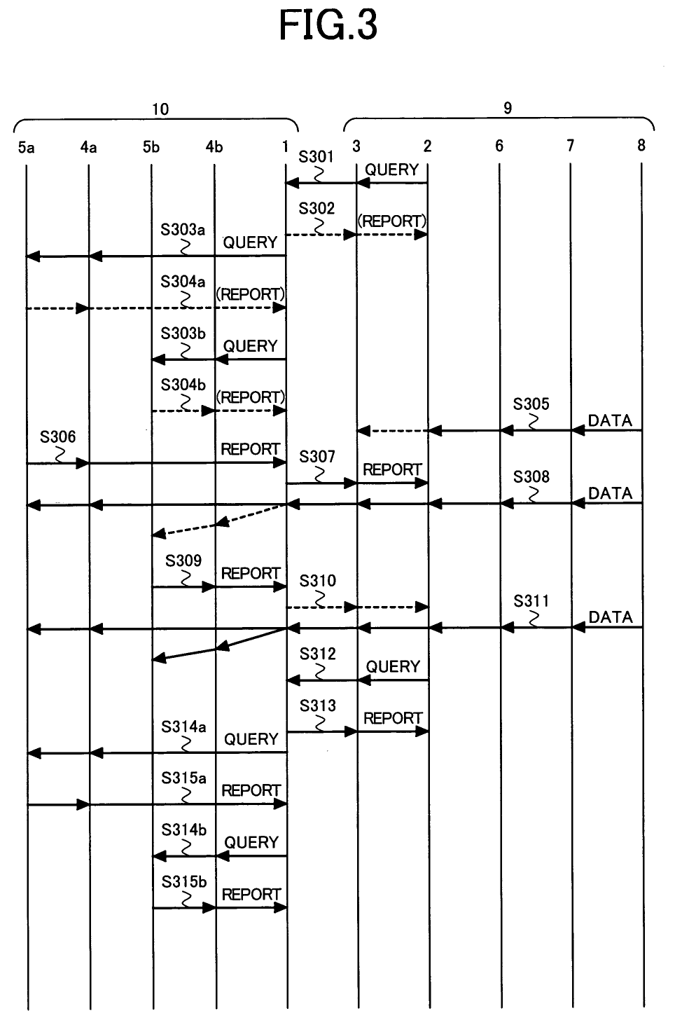

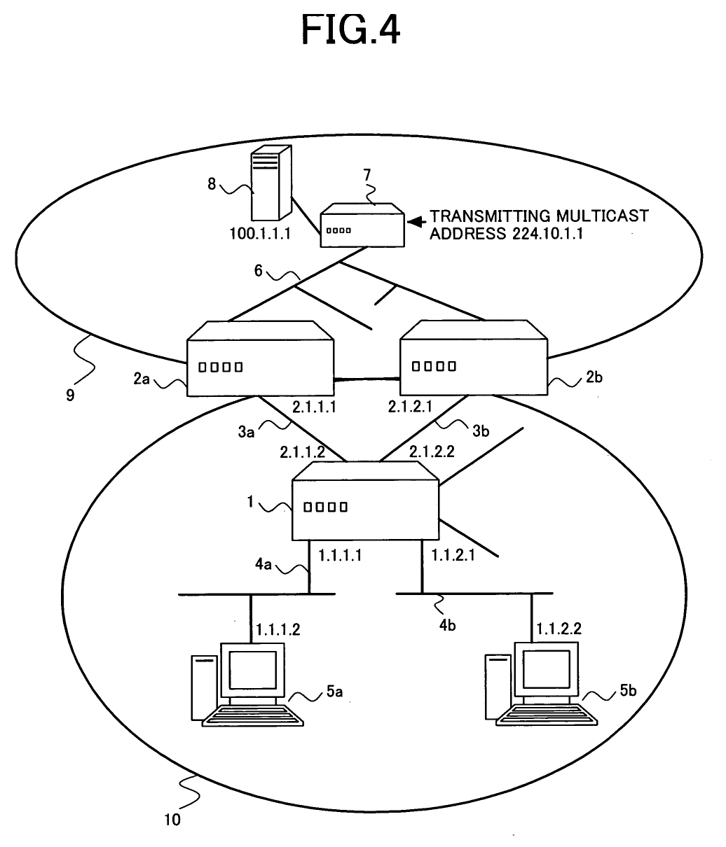

FIG. 4 is a schematic diagram of a network structure when the present invention is adapted. In comparison with FIG. 2, two upper routers 2a, 2b are provided for a router 1 and thereby two links 3a, 3b are also provided. The router 1 sets the link 3a for the upper router and also sets the link 3b for the alternative upper router.

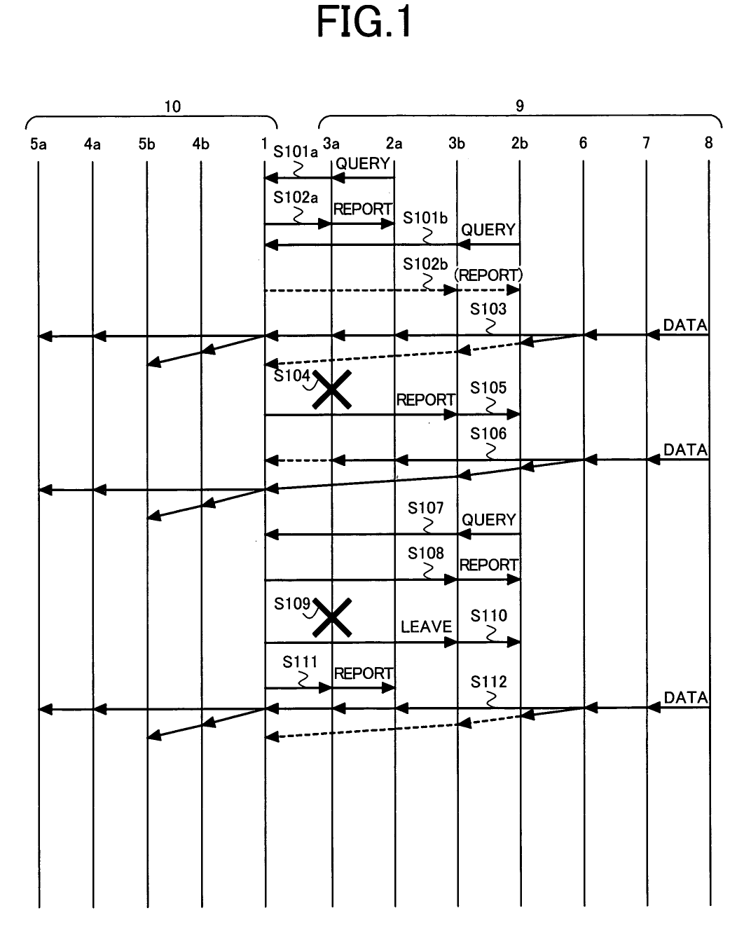

FIG. 1 is a sequence diagram of a total network of the present invention. The terminals 5a and 5b has completed registration for multicast distribution to the router 1 even in the upper most stage of this sequence diagram. Accordingly, the router 1 has also completed registration of the multicast distribution to the router 2a. When the Query message reaches from the router 2a via the link 3a under this condition (S101a), the router 1 sends a Report message as the response via the link 3a (S102a). The Query message also reaches from the router 2b via the link 3b (S101b), but the router 2b does not send the Report message as the response because the upper router is not provided in this stage (S102b). Under this condition, the multicast packet originated from the server 8 reaches both routers 2a, 2b via the multicast route 6. But, only the router 2a performs the multicast distribution and thereby the terminals 5a, 5b receive the multicast packet via the router 1 (S103). Here, a fault is generated in the link 3a (S104). The router 1 having detected a link fault generates a temporary Report message from the situation of registration of multicast distribution of the terminal under the control of this router and transmits the Report message to the router 2b via the link 3b (S105).

Therefore, multicast packet distribution to the router 1 via the router 2a in the step S103 is then changes to that via the router 2b (S106). When the Query message reaches the router 1 from the router 2 under this condition (S107), the router 1 sends the Report as the response to the router 2b (S108). When the link 3a recovers from a fault (S109), the router 1 having detected recovery of link generates the IGMP Leave Group/MLD Listener done message indicating leave from the multicast group (the Report message for leaving the group, hereinafter referred to as the Leave message, in the case of the IGMPv3/MLDv2) and then transmits this message to the router 2b via the link 3b (S110). Simultaneously, the router 1 generates the temporary Report message from the situation of registration of the multicast distribution of the terminal under the control of this router and then transmits this temporary Report message to the router 2a via the link 3a (S111). Accordingly, the multicast distribution route to the router 1 is restored to that via the router 2a as in the case of the step S103 (S112). In this example, the process has been performed to reset the distribution route to that via the router 2a simultaneously with the restoration of the link 3a. However, it is also thought that the route via the router 2b is maintained until a fault is generated in the link 3b. In this case, the Leave message is transmitted to the router 2a when the link 3a is recovered in order to eliminate double-registration.

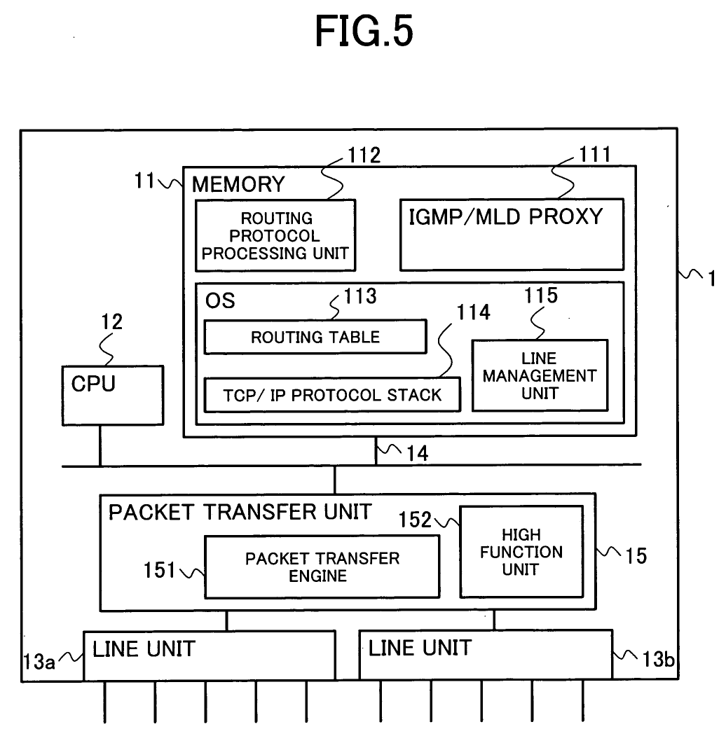

FIG. 5 is a schematic diagram of an internal structure of the router 1 in FIG. 4. A memory 11, a CPU 12, and a line unit 13 are connected with an internal transfer unit 14. The memory 11 stores a program to form a router and data required for routing. The CPU 12 performs the actual routing based on the program and data on the memory 11. The line units 13a, 13b are physically connected. Therefore, communication between the router 2, terminal 5 and the router 1 is supported with the physical layers. The internal transfer unit 14 generally uses a bus or a switch. Various programs and data regions exist within the memory 11. In this figure, only the characteristic portions are extracted. The IGMP/MLD Proxy 111 is the program for characterizing the router 1 and writes the result to a routing table 113 through actual IGMP/MLD Proxy process. A routing protocol processing unit 112 exchanges the routing protocol messages with adjacent routers and writes the result to the routing table 113. A TCP/IP protocol stack 114 actually performs transfer of IP packets and termination process based on the data stored in the routing table 113. A line management unit 115 supervises the state of the line units 13a, 13b and offers the line status information to the IGMP/MLD Proxy 111 and the routing protocol processing unit 112. These programs are basically processed with the CPU 12 but only the part in relation to the transfer of the functions of the routing table 113 and the TCP/IP protocol stack 114 is generally processed, in the recent years, in the other processor which has been additionally prepared as a specially designed processor to realize this purpose. Numeral 15 designates a packet transfer processor. This packet transfer processor comprises a packet transfer engine 151 for realizing high speed and simple transfer process with the simplified program and a high performance unit 152 for executing rather complicated processes which cannot be processed with the packet transfer engine 151 in view of conducting the packet transfer through combination of operations of these units.

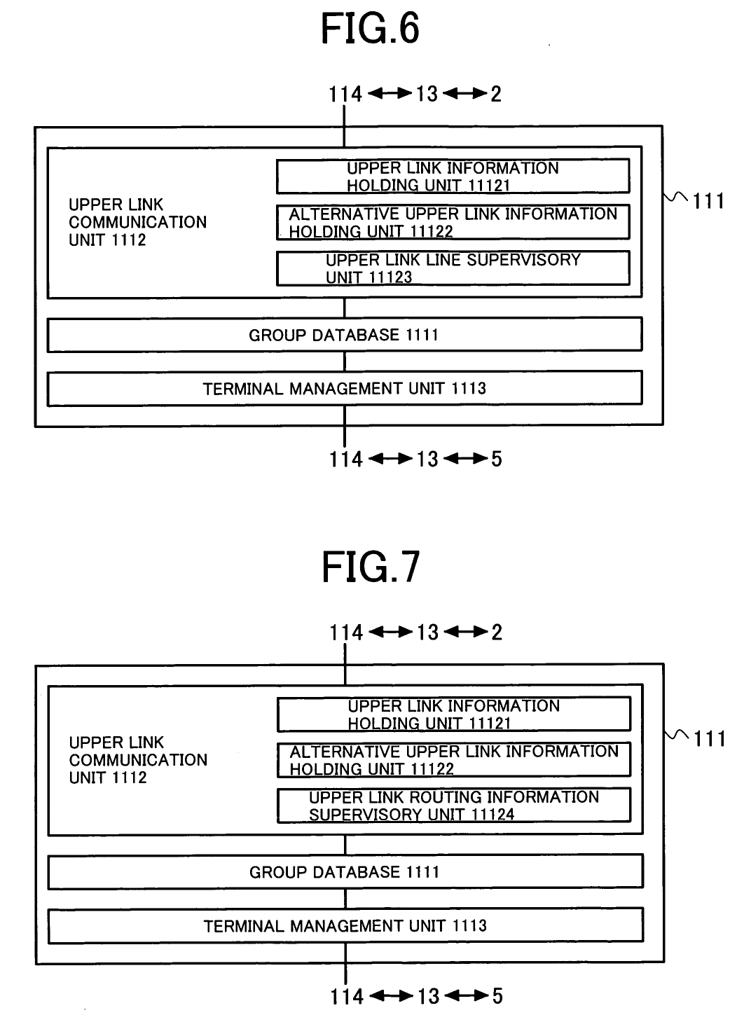

FIG. 6 is a functional block diagram of the IGMP/MLD Proxy program. A terminal management unit 1113 is connected with a terminal 5 via the TCP/IP protocol stack 114 and the line units 13a, 13b and writes the presence information of the terminal to the group data base 1111 by receiving the Report message and Leave message from the terminal. Moreover, the Query message is generated on the basis of the group database 1111 and is then transmitted periodically to the terminals. An upper link communication unit 1112 is connected to the router 2 via the TCP/IP protocol stack 114 and the line unit 13 to generate the Report message for the upper link (or the Leave message when the result of logical sum indicates vacant state) by obtaining the logical sum of the information of the group database 1111 for each group address and to transmit such Report message temporarily toward the upper router or to transmit as the response of the Query message. An upper link information holding unit 11121 actually holds the information about which line is set as the link to the upper router of the IGMP/MLD Proxy.

Moreover, the upper link communication unit 1112 is provided with an alternative upper link information holding unit 11122 and an upper link line supervisory unit 11123. The alternative upper link information holding unit 11122 holds the link information to the alternative upper router. The upper link line supervisory unit 11123 supervises the physical line information of the line being set as the upper link and replaces, when a fault is generated, the link to the upper router with the information being held in the alternative upper link information holding unit. As a method for supervising the physical line information with the upper link line supervisory unit 11123, it is thought that inquiry is made periodically to the line management unit 115 for the line status information of the line being set as the link to the upper router or setting is made to the line management unit 115 to inform change of the line status information when this change actually occurs.

In the case of this system, it is impossible to repair a fault occurring in the IP layer such as a fault of the upper router itself but a link fault may probably be detected most quickly.

FIG. 9 illustrates an example of the group database in FIG. 4. A membership record is expressed with a set (of the multicast address, filter mode, and source address list). This set corresponds to the IGMPv3/MLDv2 in which the filter mode becomes, in the IGMPv2/MLDv1, “EXCLUDE” meaning that the source address is not included or “NULL” meaning that the source address is vacant. In the example of FIG. 4, the multicast address becomes 224.10.1.1, source address becomes (100.1.1.1) and filter mode becomes the “INCLUDE” meaning that the source address is included and the transfer destination (address) becomes 1.1.1.2 and 1.1.2.2 which are respectively the addresses of the terminals.

### Second Embodiment

The network structure and total sequence of the network are identical to that in the first embodiment. FIG. 7 is a functional block diagram of the IGMP/MLD Proxy program in the present invention which is a modification example of the example in FIG. 6. The upper link communication unit comprises an alternative upper link information holding unit 11122 and an upper link routing information supervisory unit 11124. The alternative upper link information holding unit 11122 holds the link information to the alternative upper router. The upper link routing supervisory unit 11124 supervises the link status information of the IP unicast routing protocol such as OSPF and BGP which are operating on the line being set as the upper link and replaces, if a fault occurs, the link to the upper router with the information being stored in the alternative upper link information holding unit. As a method for supervising the IP unicast information with the upper link routing information supervisory unit 11124, it is thought that an inquiry is made periodically to the routing table 113 for the link being set as the link to the upper router or setting is made to the routing protocol processing unit 112 to notify change in the routing status information of the link when such change actually occurs.

This system may probably take a longer time for decision of a link fault than that required in the first embodiment because the process for deciding link-off (usually, timeout is used) due to the unicast routing protocol is executed unlike the first embodiment but is ready for a fault in the IP layer such as a fault of the upper router itself.

### Third Embodiment

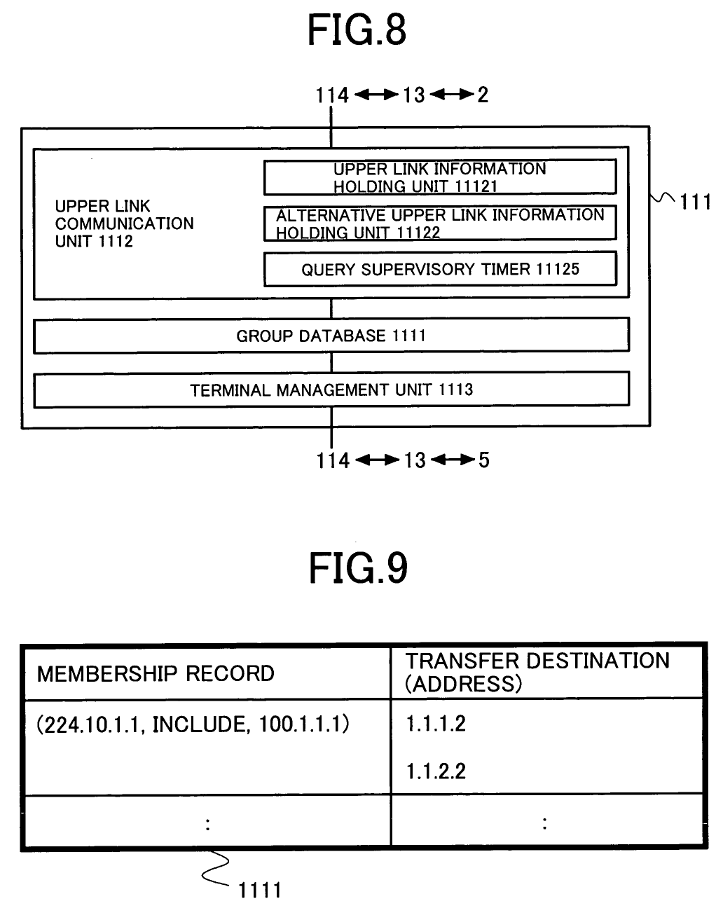

The network structure and the total sequence of the network are identical to that in the first embodiment. FIG. 8 is a functional block diagram of the IGMP/MLD Proxy which is a modification of the example of FIG. 6. The upper link communication unit comprises an alternative upper link information holding unit 11122 and a Query supervisory timer 11125. The alternative upper link information holding unit 1112 holds the link information to the alternative upper router. The Query supervisory timer 11125 measures an interval of occurrence of the Query message from the line being set as the upper link and assumes, if the Query message does not reach for a constant period of time, this situation as occurrence of a fault and replaces the link to the upper router with the information being held in the alternative upper link information holding unit.

Since the interval of the Query messages is usually longer than the time required for decision of link-off with the unicast routing protocol, this system may probably take a longer time for decision of link-off than that in the second embodiment, but is also ready for a fault occurring in the special IP layer such as a fault generated only in the multicast function of the upper router.

Here, it is also possible in the present invention to cover every situation by simultaneously loading the first to the third embodiments.

Moreover, in the embodiments explained above, an example in which the routing has been made by processing with the CPU the data and program stored in the memory has been explained but the memory and the CPU operates as a control apparatus through the cooperative operations thereof. Therefore, it is also possible to realize the similar function by constituting the software with the hardware structure. In addition, as is already explained above, a part of the function may be replaced with the other exclusive hardware and software (for example, the packet transfer processor 15).

What is claimed is:

1. A IGMP/MLD Proxy router comprising:
a memory for storing the upper link information and the alternative upper link information,
a processor for controlling routing,
a line unit physically connected to an upper link and an alternative upper link to make communications in accordance with control of said processor, and
an internal transfer unit for connecting said memory, processor, and line unit,
whereby said processor can transmit the IGMP/MLD Report to said alternative upper link when a fault in said upper link is detected and thereafter executes the control for switching said upper router by sending a response to the Query from said alternative upper link.

2. The IGMP/MLD Proxy router according to claim 1, wherein said processor can detect a link fault by detecting a physical fault of an upper link line.

3. The IGMP/MLD Proxy router according to claim 1, wherein said processor can detect a link fault by utilizing the IP unicast routing information for the upper router.

4. The IGMP/MLD Proxy router according to claim 1, wherein said processor assumes occurrence of a link fault when the IGMP/MLD Query message does not reach from the upper router for the predetermined constant period.

5. A communication apparatus comprising:
a control unit including a memory and a CPU for conducting routing control based on the information stored in said memory,
a line unit physically connected to an upper link and an alternative upper link, and
a internal transfer unit for mutually connecting said memory, CPU, and line unit, wherein
said control unit including
an IGMP/MLD Proxy for executing the IGMP/MLD Proxy process,
a routing protocol processing unit for conducting the routing protocol process through exchange of the routing protocol message with the other communication apparatus,
a routing table for storing the result of said IGMP/MLD Proxy process and the result of said routing protocol process,
a TCP/IP protocol stack for conducting the IP packet transfer and the termination process on the basis of the data stored in said routing table, and
a line management unit for supervising state of said line unit and offering the line status information to said IGMP/MLD Proxy and routing protocol processing unit, and
said IGMP/MLD Proxy including
a terminal management unit for receiving the participating and leaving messages of multicast group from terminals,
a group database for storing terminal information on the basis of the receiving result of said terminal management unit,
an upper link information holding unit for holding the information indicating which line is actually set as the link to the upper router of the IGMP/MLD Proxy,
an upper link line supervisory unit for supervising the physical line information of the line being set as the upper link and for replacing the link to the upper router with the information stored in the alternative upper link information holding unit when a fault occurs, and an upper link communication unit for making communication with said upper link or said alternative upper link.

6. An IGMP/MLD Proxy router comprising:
a control unit for executing routing control,
a line unit physically connected to an upper link and an alternative upper link, and
an internal transfer unit for mutually connecting said control unit and line unit
for routing of multicast packets by terminating the IGMP/MLD packets received from the terminals and transmitting the IGMP/MLD packets to the upper link as the alternative of said terminals, wherein
said control unit including
a terminal management unit for receiving participating and leaving messages to said multicast group from said terminals,
a group database for storing terminal information on the basis of the receiving result of said terminal management unit, and
an upper link communication unit for transmitting the IGMP/MLD Report to said alternative upper link when a fault of said upper link is detected and thereafter conducting control to switch an upper router by sending a response to the Query from said alternative upper link.

7. The IGMP/MLD Proxy router according to claim 6, wherein said upper link communication unit detects a link fault by detecting a physical fault of the upper link line.

8. The IGMP/MLD Proxy router according to claim 6, wherein said upper link communication unit detects a link fault by utilizing the IP unicast routing information for the upper router.

9. The IGMP/MLD Proxy according to claim 6, wherein said upper link communication unit assumes occurrence of a link fault, if the IGMP/MLD Query message from the upper router does no reach for the predetermined constant period.
